(19) United States
(12) Patent Application Publication
(10) Pub. No.: US 2020/0320090 A1
(43) Pub. Date: Oct. 8, 2020

(54) METHOD AND DEVICE FOR DATA FUSION, NON-TRANSITORY STORAGE MEDIUM AND SERVER

(71) Applicant: Shanghai Zamplus Rongxuan Technology Co., Ltd., Shanghai (CN)

(72) Inventors: Qifeng TANG, Shanghai (CN); Shaojun NING, Shanghai (CN)

(73) Assignee: Shanghai Zamplus Rongxuan Technology Co., Ltd., Shanghai (CN)

(21) Appl. No.: 16/546,119

(22) Filed: Aug. 20, 2019

(30) Foreign Application Priority Data
Apr. 2, 2019 (CN) 201910259557.X

(51) Int. Cl. G06F 16/25; G06K 9/62; G06F 16/901

(52) U.S. Cl. CPC G06F 16/258; G06F 16/9024; G06K 9/6218; G06K 9/6215

(57) ABSTRACT

A method and a device for data fusion, a non-transitory storage medium and a server are provided, wherein the method includes: performing a data structuring on an obtained set of data to obtain a structured data set including a plurality of structured data; selecting any two pieces of structured data in the structured data set to form a plurality of structured data pairs; performing a similarity calculation on each of the plurality of structured data pairs to obtain a similarity value for each structured data pair; and when the similarity value is greater than a predetermined similarity threshold, classifying structured data in the structured data pair into a same data subject. In embodiments of the present disclosure, whether the data belongs to the same data body can be determined, which provides technical support for data fusion.

### CROSS-REFERENCE TO RELATED APPLICATIONS

This application claims the benefit of priority to Chinese Patent Application No. 201910259557.X, filed on Apr. 2, 2019. The entire contents of this application are hereby incorporated herein by reference.

### TECHNICAL FIELD

The present disclosure relates to the field of big data processing technology, and more particularly, to a method and a device for data fusion, a non-transitory storage medium and a server.

### BACKGROUND

We are in an age of big data, and there are a large amount of data related to urban operation and urban management. For an example, there are urban traffic data, resident residence information, demographic data, public opinion data, and the like. For another example, there are sensor data, government data, public data, business data, and the like.

Generally, data from different fields are used to describe various aspects of a data subject (for example, a city management subject). Even if data belongs to the same data subject, different names or different numbers may be used in each data. Even the data subject identifier information may not be included in the data. Therefore, in most cases, it is difficult to infer directly from the data the data subject to which each data belongs.

In order to describe the data subject (for example, the city management subject) more diversifiedly and comprehensively, it is necessary to associate and fuse heterogeneous data from different sources, to aggregate different data with the same data subject in the real world for subsequent analysis and processing.

### SUMMARY

The technical problem solved by the present disclosure is how to process heterogeneous data from different sources to determine a data subject.

Embodiments of the present disclosure provide a method for data fusion, including: performing a data structuring on an obtained set of data to obtain a structured data set including a plurality of structured data; selecting any two pieces of structured data in the structured data set to form a plurality of structured data pairs; performing a similarity calculation on each of the plurality of structured data pairs to obtain a similarity value for each structured data pair; and classifying structured data in the structured data pair with the similarity value greater than a predetermined similarity threshold into a same data subject.

In some embodiments, each piece of data in the set of data includes feature information, wherein the feature information includes at least one of the following items: time information, spatial location information, and identification information of the data subject.

In some embodiments, the performing a data structuring on an obtained set of data to obtain a structured data set including a plurality of structured data includes: for the set of data, extracting feature information carried in each piece of the data to obtain respective feature extraction result for each piece of data; for each feature extraction result of each piece of data, performing the data structuring on each feature extraction result in accordance with at least one of time information, spatial location information, and identification information of the data subject to obtain all data features of each piece of data; processing all data features of each piece of data in accordance with a predetermined structured data format to obtain the plurality of structured data for each piece of data; and forming the structured data set based on the plurality of structured data for each piece of data.

In some embodiments, the performing a similarity calculation on each of the plurality of structured data pairs includes: for any structured data in each structured data pair, based on a predetermined subject knowledge library, attempting to extract a subject feature from all data features of the structured data, wherein the predetermined subject knowledge library includes a plurality of data subjects, and at least one subject feature for representing each data subject, wherein the at least one subject feature is configured to uniquely identify a data subject to which the structured data belongs; and if both of two pieces of structured data in the structured data pair include the subject feature, performing the similarity calculation on the two subject features.

In some embodiments, the subject feature is described by a plurality of subject identifiers, and the performing the similarity calculation on the two subject features includes: determining a cross subject identifier of the two subject features to obtain at least one cross subject identifier pair; performing the similarity calculation on the at least one cross subject identifier pair when there is at least one cross subject identifier pair to obtain similarity calculation results for the at least one cross subject identifier pair respectively; and weighting the respective similarity calculation result for the at least one cross subject identifier.

In some embodiments, the performing the similarity calculation on the at least one cross subject identifier pair includes: using a cosine similarity formula to perform the similarity calculation on the at least one cross subject identification pair.

In some embodiments, the performing a similarity calculation on each of the plurality of structured data pairs includes: for any structured data in each structured data pair, based on a predetermined subject knowledge library, attempting to extract a subject feature from all data features of the structured data, wherein the predetermined subject knowledge library includes a plurality of data subjects, and at least one subject feature for representing each data subject, wherein the at least one subject feature is configured to uniquely identify a data subject to which the structured data belongs; based on a predefined subject dimension library, extracting other data features in the structured data except the subject feature, wherein the predefined subject dimension library includes various data features for describing the data subject; for any structured data in each structured data pair, performing the similarity calculation on the subject feature and the other data features respectively to obtain similarity calculation results for the subject feature and the other data features; and weighting the similarity calculation results of the subject feature and the other data features.

In some embodiments, the performing the similarity calculation on the subject feature and the other data features respectively includes: using a cosine similarity formula to perform the similarity calculation on the subject feature and the other data features respectively.

In some embodiments, the method for data fusion further includes: fusing data features in the structured data belonging to the same data subject.

In some embodiments, the fusing data features in the structured data belonging to the same data subject includes: using an inter-relationship diagraph to fuse data features in the structured data belonging to the same data subject.

Embodiments of the present disclosure provide a device for data fusion, including: a structured processing circuitry, configured to perform a data structuring on an obtained set of data to obtain a structured data set including a plurality of structured data; a selecting circuitry, configured to select any two piece of structured data in the structured data set to form a plurality of structured data pairs; a calculating circuitry, configured to perform a similarity calculation on each of the plurality of structured data pairs to obtain a similarity value for each structured data pair; and a classifying circuitry, when the similarity value is greater than a predetermined similarity threshold, configured to classify structured data in the structured data pair into a same data subject.

Embodiments of the present disclosure provide a non-transitory storage medium, storing computer instructions, wherein once the computer instructions are executed, the method for data fusion is performed.

Embodiments of the present disclosure provide a server, including a memory and a processor, wherein the memory stores computer instructions executable on the processor, and the processor executes the method for data fusion when executing the computer instructions.

Embodiments of the present disclosure have the following advantages.

Embodiments of the present disclosure provide a method for data fusion, including: performing a data structuring on an obtained set of data to obtain a structured data set including a plurality of structured data; selecting any two pieces of structured data in the structured data set to form a plurality of structured data pairs; performing a similarity calculation on each of the plurality of structured data pairs to obtain a similarity value for each structured data pair; and classifying structured data in the structured data pair with the similarity value greater than a predetermined similarity threshold into a same data subject. In embodiments of the present disclosure, after processing the data into structured data, the similarity between the two structured data pairs may be calculated, and whether the two pieces of structured data are belong to one data subject may be determined using the similarity value and the predetermined similarity threshold. Therefore, it can be determined whether heterogeneous data from different sources belongs to a same data subject, and if yes, it is beneficial to enrich the data information of the data subject (for example, a smart city management subject) and make it comprehensive, thereby providing a more comprehensive data foundation for data analysis and mining.

Further, performing the similarity calculation on the two subject features includes: determining a cross subject identifier of the two subject features to obtain at least one cross subject identifier pair; performing the similarity calculation on the at least one cross subject identifier pair when there is at least one cross subject identifier pair to obtain similarity calculation results for the at least one cross subject identifier pair respectively; and weighting the respective similarity calculation result for the at least one cross subject identifier. In embodiments of the present disclosure, when calculating the similarity, whether the two pieces of structured data belong to the same data subject can be determined by the similarity calculation of the subject identifier. If yes, the similarity calculation for other data features of the two pieces of structured data may be avoided, which reduces computational complexity and speeds up data fusion.

Further, the method for data fusion further includes: fusing data features in the structured data belonging to the same data subject. In embodiments of the present disclosure, after determining that the two pieces of structured data belong to the same data subject, two pieces of structured data can be fused into the data subject. Therefore, the data subject can obtain more comprehensive data information, which facilitates providing effective data for data analysis mining.

### BRIEF DESCRIPTION OF THE DRAWINGS

FIG. 1 schematically illustrates a flow diagram of a method for data fusion according to an embodiment of the present disclosure;

FIG. 2 schematically illustrates a flow diagram of an embodiment for S101 shown in FIG. 1; and

FIG. 3 schematically illustrates a structural diagram of a device for data fusion according to an embodiment of the present disclosure.

### DETAILED DESCRIPTION

As described in the background, in the existing technology, it is difficult to directly determine which heterogeneous data belongs to a same data subject, which brings inconvenience to data analysis and mining.

Taking a data source of a smart city as an example, each data source records and describes a real-world data subject, such as roads, communities, shopping malls, buildings, people, and so on. However, different data sources may have different identifiers or designation for a same data subject. For example, a name of a community is Kangqiao Shuidu, which is called as “Kangqiao Shuidu” by some data sources, or as “Shuidu”, “Lianhuashan Road No. 700 (Address)” by other data sources.

It can be seen that although the data information in different data sources is obtained for the same data subject “Kangqiao Shuidu”, but the name or the identification information is different, if the above data is not processed, it may not be merged in the subsequent data processing, which put an adverse impact on subsequent data mining.

Embodiments of the present disclosure provide a method for data fusion, which includes: performing a data structuring on an obtained set of data to obtain a structured data set including a plurality of structured data; selecting any two pieces of structured data in the structured data set to form a plurality of structured data pairs; performing a similarity calculation on each of the plurality of structured data pairs to obtain a similarity value for each structured data pair; and classifying structured data in the structured data pair with the similarity value greater than a predetermined similarity threshold into a same data subject.

In embodiments of the present disclosure, after processing the data into structured data, the similarity between the two structured data pairs may be calculated, and whether the two pieces of structured data are belong to one data subject may be determined using the similarity value and the predetermined similarity threshold. Therefore, it can be determined whether heterogeneous data from different sources belongs to a same data subject, and if yes, it is beneficial to enrich the data information of the data subject (for example, a smart city management subject) and make it comprehensive, thereby providing a more comprehensive data foundation for data analysis and mining.

The foregoing objects, features and advantages of the present disclosure will become more apparent from the following detailed description of specific embodiments in conjunction with the accompanying drawings.

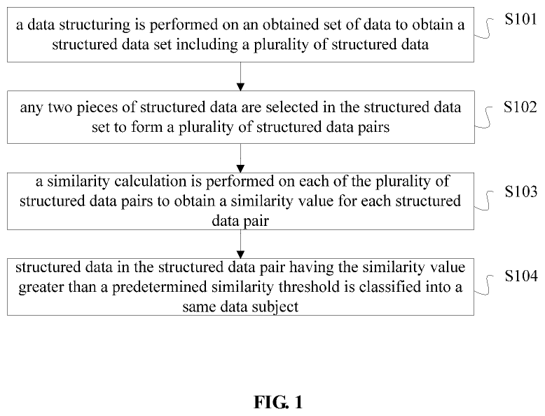

FIG. 1 schematically illustrates a flow diagram of a method for data fusion according to an embodiment of the present disclosure. The method for data fusion may be applied to a server side. In some embodiments, the server may be a single server or a server cluster including a plurality of servers.

Specifically, the method of data fusion may include following steps.

S101: a data structuring is performed on an obtained set of data to obtain a structured data set including a plurality of structured data.

S102: any two pieces of structured data are selected in the structured data set to form a plurality of structured data pairs.

S103: a similarity calculation is performed on each of the plurality of structured data pairs to obtain a similarity value for each structured data pair.

S104: structured data in the structured data pair having the similarity value greater than a predetermined similarity threshold is classified into a same data subject.

More specifically, the server may acquire a set of data by means of a file transfer protocol (FTP) or an application programming interface (API) for online collection. For example, the server accesses data from various sources belonging to a smart city through FTP, API, and the like.

Generally, each piece of data may include one or more of feature information such as time information, spatial location information, identification information of the data subject, and the like.

In one embodiment, for online, real-time collected data, the server can perform data reception and storage recording through a real-time online service. For offline batch data, data reception and storage recording can be performed through FTP, Secure File Transfer Protocol (SFTP) or a page upload function, which may obtain the set of data.

Then, in S101, the server may perform a structured processing on each obtained data to obtain a plurality of structured data. Further, individual structured data may be aggregated into a structured data set.

In some embodiments, considering that the time information, the spatial location information, and the identification information of the data subject that are included in each data are various. Therefore, the data may be structured in a time dimension, a spatial dimension, and a semantic level to obtain structured data for the original data.

The semantic level refers to a category of the identification information configured to identify the data subject contained in the data, which is determined using a predetermined semantic library of the data subject (for example, a semantic library of the smart city subject). It is assumed that data A contains information: “Wangjia Village, No. 100 Shuangyang Road”, and after processing through the semantic level, it can be obtained that the identification information contained in the data A includes “name feature” and “address feature”.

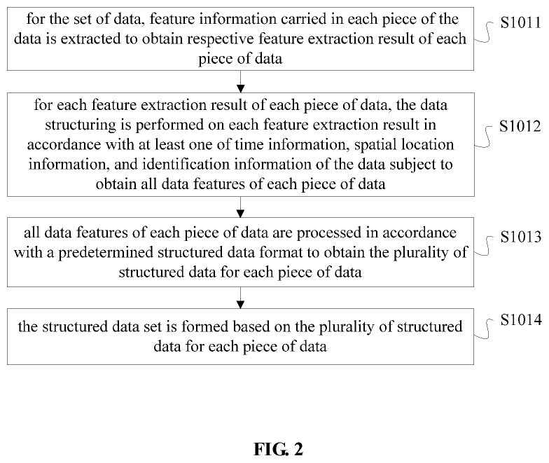

In some embodiments, referring to FIG. 2, S101 may include following steps.

In S1011, for the set of data, feature information carried in each piece of the data is extracted to obtain respective feature extraction result of each piece of data.

In S1012, for each feature extraction result of each piece of data, the data structuring is performed on each feature extraction result in accordance with at least one of time information, spatial location information, and identification information of the data subject to obtain all data features of each piece of data.

In S1013, all data features of each piece of data are processed in accordance with a predetermined structured data format to obtain the plurality of structured data for each piece of data.

In S1014, the structured data set is formed based on the plurality of structured data for each piece of data.

Specifically, in S1011, the feature information carried in each piece of data may be extracted in the set of data, which obtains a feature extraction result of each piece of data.

In step S1012, the feature extraction result for each piece of data may be structured, for example, the feature extraction result for each piece of data is structured according to at least one of time information, spatial position information, and identification information of the data subject, which may obtain all data features of each piece of data.

In some embodiments, the time information may be structured according to a date, a date type (e.g., a working day, a holiday) and/or a time period (e.g., 2 to 6 o'clock, 6 to S o'clock, 8 to 9 o'clock, 9 to 12 o'clock, 12 to 17 o'clock, 17 to 19 o'clock, 19 to 22 o'clock, and 22 to 2 o'clock).

In some embodiments, the spatial location information may be structured according to a spatial dimension, for example, an Internet Protocol (IP) address, latitude and longitude information, and a point of interest (Point of Interest, POI) in the data or the like may be extracted as the spatial location information and converted into geographical location information in an actual application.

In some embodiments, the identification information indicating the data subject in the data may be extracted and structured. For example, the identification information of the data subject is extracted according to semantic information included in the data and the predetermined data subject semantic library. Thereafter, the data is structured, which associated with the data subject, to obtain identification information of the data subject included in the data, such as a cell name, a road name, and the like.

In S1013, each piece of data may be processed to store all data features of each piece of data in a predetermined structured data format to obtain structured data for each piece of data.

For example, the data obtained is: Xiao Ming appeared at 31.2233, 121324 at 14784829552. When extracting feature information, “Xiao Ming” may be used as the identification information of the data subject. “14784829552” is used as time information (i.e., a timestamp); when data is further structured, “14784829552” can be translated into 14:28:24 on Feb. 14, 2016. Further, according to a predetermined structured data format, “14:28:24 on Feb. 14, 2016” is converted into a date (Feb. 14, 2019) and a time period (2 pm to 4 pm).

Further, “31.2233, 121324” may be used as the spatial location information (e.g., latitude and longitude information), and the latitude and longitude information may be translated into a Shanghai Lingshi Road Haode convenience store. Afterwards, the data is structured with the semantic level, and according to the predetermined structured data format, the “Shanghai Lingshi Road Haode Convenience Store” can be converted into: province, Shanghai; city, Shanghai; district, Jing'an District; street, Daning Street; shore name: Haode convenience store.

Further, it is assumed that the predetermined structured data format is <name>, <gender>, <date>, <time period>, <province>, <city>, <district>, <street>, <store name>. Under this assumption, “Xiao Ming appeared at 31.2233, 121324 at 14784829552.” The structured data obtained is <Xiaoming>, <>, <Feb. 14, 2016>, <2 pm to 4 pm>, <Shanghai>, <Shanghai>, <Jing'an District>, <Danning Street>, <Haode Convenience Store>.

Further, in S1014, the structured data set may be formed based on the plurality of structured data for each piece of data.

In S102, for the structured data set, the structured data therein may be combined in pairs to obtain a plurality of structured data pairs.

In S103, a similarity calculation may be performed on each structured data pair obtained from step S102 to obtain a similarity value for each structured data pair.

In some embodiments, based on a predetermined subject knowledge library, a subject features in all data features maybe extracted from all data features of the structured data.

The predetermined subject knowledge library includes a plurality of data subjects, and at least one subject feature for representing each data subject, wherein the at least one subject feature is configured to uniquely identify a data subject to which the structured data belongs, for example, a string representing a unique data subject. In one embodiment, the data subject is a building, and the predetermined subject knowledge library may include data features such as a geofence boundary, an address, a name, an abbreviation, and a national standard number.

The predetermined subject knowledge library has a plurality of construction methods. For example, a predetermined subject knowledge library for the real estate may be constructed based on an authoritative real estate network and/or a government official website. The predetermined subject knowledge library for the real estate may include a cell name, a cell abbreviation, a cell address, a cell boundary, a cell keyword, a property management company name, a category, and the like.

Thereafter, whether both of two pieces of structured data in the structured data pair include the subject feature is determined, and if yes, the similarity calculation may be performed on the two subject features.

In an embodiment, the subject feature is described by a plurality of subject identifiers. In this case, When performing the similarity calculation on the two subject features, whether the two subject features have cross subject identifiers is determined firstly, and if no, the similarity calculation ends; if yes, at least one cross subject identifier pair may be obtained.

Thereafter, the similarity calculation may be performed on the at least one cross subject identifier pair using a cosine similarity formula, which obtains similarity calculation results for the at least one cross subject identifier pair respectively. The cosine similarity formula, also known as the cosine similitude formula, evaluates the similarity of two vectors by calculating a angle cosine of the two vectors.

Specifically, the cosine similarity formula is as follows:

$$\frac{{\sum }_{i = 1}^{n} Ai \times Bi}{\sqrt{{\sum }_{i = 1}^{n} {( Ai )}^{2}} \times \sqrt{{\sum }_{i = 1}^{n} {( Bi )}^{2}}} ,$$

A and B respectively represent a vector formed by cross subject identifiers in the structured data pair. Ai, Bi respectively represent an i-th component of the vector A and the vector B, and n represents the number of the cross subject identifiers, wherein both of i and n are positive integers.

Further, the respective similarity calculation result for the at least one cross subject identifier may be weighted, to obtain the similarity value of the structured data pair.

If the similarity value is greater than a predetermined similarity threshold, it may be determined whether the two pieces of structured data in the structured data pair belong to a same data subject, and thus the similarity calculation for the remaining data features may be avoided, which reduces computational complexity and speeds up fusion.

In some embodiments, the predetermined similarity threshold may be obtained based on a training by a training set.

In one embodiment, for any structured data in each structured data pair, based on a predetermined subject knowledge library, a subject feature in all data features may be attempted to extract from all data features of the structured data.

The predetermined subject knowledge library includes a plurality of data subjects, and at least one subject feature for representing each data subject, wherein the at least one subject feature is configured to uniquely identify a data subject to which the structured data belongs.

Thereafter, based on a predefined subject dimension library, other data features in the structured data except the subject feature may be extracted, wherein the predefined subject dimension library includes various data features for describing the data subject.

Taking a predefined subject dimension library for the smart city as an example, the predefined subject dimension library for the smart city may include various typical data features of a city management data subject. Usually, different data subjects have different predefined subject dimensions, which is constructed by typical features of the data subject.

Further, for any structured data in each structured data pair, the similarity calculation may be performed on the subject feature and the other data features respectively to obtain similarity calculation results for the subject feature and the other data features. In some embodiment, the cosine similarity formula may be configured to perform the similarity calculation.

Thereafter, the similarity calculation results of the subject feature and the other data features may be weighted to obtain a similarity value of the structured data pair. A weighting coefficient may be predetermined according to each data feature.

An embodiment is shown in the following for explanation.

It is assumed that the identification information of two pieces of structured data included in a structured data pair is data A and data B, respectively. Data features extracted from data A are shown as follows: name feature: name (** cell), keyword (** road), administrative region (** area, ** street); online behavior feature: APP (WeChat, Dianping); address, location feature: IP address (****), POI (***, ****). Data features extracted by data B are shown as follows: name feature: keyword (** road), administrative region (** area, ** street); address, location feature: IP address (****), POI (* **, ****), wherein “*” indicates content of each data feature.

If the predetermined structured data format is: feature identifier {<name feature>, <address, location-related feature>, <online behavior feature>, <time feature>}. Thus, A{<name feature>, <address, location-related feature>, <online behavior feature>, <time feature>}, and B{<name feature>, <address, location-related feature>, <online behavior feature>, <time feature>} may be obtained.

Thereafter, data A and data B form a structured data pair. For example, it may be <A{<name feature>, <address, location-related feature>, <online behavior feature>, <time feature>}, B{<name feature>, <address, location-related feature>, <online behavior feature>, <time feature>}>.

Thereafter, a cross subject identifier and other cross data features of data A and data B are determined, which obtained by A∩B={name feature, location-related feature}.

Further, a feature filtering may be performed on each cross data feature, only cross data features are preserved, and other non cross data features are filtered out. For example, a cross data pair formed by data A and data B, after data features are filtered, may obtain a cross feature <A{<keyword>, <administrative region>, <IP address>, <POI>}>, B{<keyword>, <administrative region>, <IP address>, <POI>}>.

Further, the similarity calculation formula for each data feature may be configured to calculate the similarity of each data feature.

For example, the similarity between subject features is represented by Sd, and Sd may be calculated using the cosine similarity formula. Specifically, a calculation dimension includes each cross subject feature, and the respective cross subject features are combined to obtain a vector space of the subject feature. Thereafter, the cosine similarity formula may be configured to calculate the value of Sd.

The similarity between the IP address, location-related features represented by Sp may also be calculated using the cosine similarity formula. Specifically, a calculation dimension includes an IP address value, and a location POI, which are combined to obtain a vector space. Thereafter, the cosine similarity formula may be configured to calculate the value of Sp.

The similarity between the online behavioral features represented by So may also be calculated using the cosine similarity formula. A calculation dimension includes an application (APP) name, a website name, a host name, and a user agent (UA) name, which are combined to obtain a vector space. Thereafter, the cosine similarity formula may be configured to calculate the value of So.

The similarity between the time features represented by St may also be calculated using the cosine similarity formula. Specifically, a calculation dimension includes a specific date, a date type (e.g., a working day or a holiday), and a time period value, which are combined to obtain a vector space. Thereafter, the cosine similarity formula may be configured to calculate the value of St.

Further, the similarity of the data features may be weighted and calculated to obtain an overall similarity of data A and data B. Specifically, a result can be obtained according to the similarity of each data feature with being weighted by a predetermined weight, and the formula is as follows: S=a·Sd+b·Sp+c·So+d·St.

a, b, c, d represent the weighting coefficients of respective data features, S represents the similarity value of the two pieces of structured data, Sd represents the similarity of subject features, and Sp represents the IP address, location-related features. So represents the similarity of online behavioral features, and St represents the similarity of time features.

Those skilled in the art understand that in practical applications, more data features may be included to obtain more accurate similarity values for the two pieces of structured data.

In S104, classifying structured data in the structured data pair with the similarity value greater than a predetermined similarity threshold into a same data subject.

In some embodiments, the data subject may be represented by an existing subject identifier, or a string may be generated for uniquely identifying the data subject.

Further, the data features in the structured data belonging to the same data subject can be fused, which may make the data features of the data subject richer and more comprehensive.

In some embodiments, an inter-relationship diagraph may be used to fuse data features in the structured data belonging to the same data subject. When the inter-relationship diagraph is used, subject identifiers in the same graph are classified into a same data subject, and the subject identifiers which generate the data subject may form a data set for the data subject.

The inter-relationship diagraph has a delivery function. If a subject identifier A is associated with the subject identifier B and the subject identifier B is associated with the subject identifier C, the subject identifier A and the subject identifier B are associated with the subject identifier C, that is, the subject identifier A, the subject identifier B, and the subject identifier C belong to a same data subject.

For example, it is assumed that the data subject is a person. In one piece of data, the person uses a phone number 135XX XXX to order a takeaway to the Zhujiang Creative Park at XX time (for example, 16:38 on Mar. 1, 2019). In another data, Xiao Ming registered his household information at the Ping An Neighborhood Committee during XX time (11:31 on Mar. 12, 2019). In a third data, an office address of a householder who lives in Room 31, Lane 209, Lianhuashan Road is Nanshan Science and Technology Park.

According to the data fusion method provided by embodiments of the present disclosure, if “telephone number 135XXXXX”, Xiaoming, and the householder who lives in Room 31, Lane 209, Lianhuashan Road belong to the same data subject, the character “A” can be configured to represent them. Under this condition, the three pieces data can be changed to the following format.

A ordered a takeaway to the Zhujiang Creative Park at 16:38 on Mar. 1, 2019.

A registered household information at the Ping An Neighborhood Committee at 11:31 on Mar. 12, 2019.

The office address of A is Nanshan Science and Technology Park.

Further, the data fusion result may he: A o A ordered a takeaway to the Zhujiang Creative Park at 16:38 on Mar. 1, 2019, registered household information at the Ping An Neighborhood Committee at 11:31 on Mar. 12, 2019, and has the office at Nanshan Science and Technology Park.

From the above, the embodiment of the present invention can effectively and quickly determine whether two data belong to the same data body, and provide technical support for data fusion. Further, the data information of the same data subject can be integrated, which is beneficial to enriching and comprehensively data information of the data subject (for example, smart city management), and is beneficial to provide a more comprehensive data foundation for data analysis and mining.

Therefore, in embodiments of the present disclosure, whether two pieces of data from different sources belong to a same data subject can be determined effectively and quickly to provide technical support for data fusion. Further, the data belongs to the same data subject can be fused, which is beneficial to enrich the data information of the data subject (for example, a smart city management subject) and make it comprehensive, which is beneficial to provide a more comprehensive data foundation for data analysis and mining.

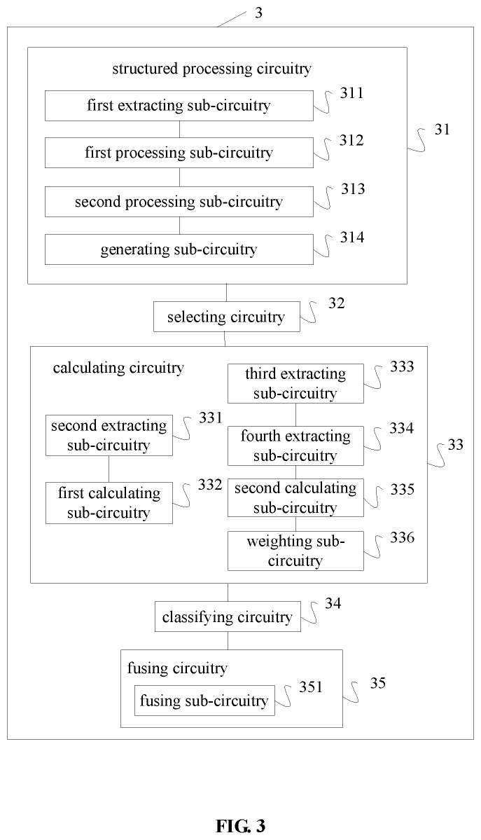

FIG. 3 schematically illustrates a structural diagram of a device for data fusion according to an embodiment of the present disclosure. The device 3 for data fusion may be configured to implement the technical solution of the method shown in FIG. 1 and FIG. 2, which is executed by the server side.

Specifically, the device 3 for data fusion may include: a structured processing circuitry 31, configured to perform a data structuring on an obtained set of data to obtain a structured data set including a plurality of structured data; a selecting circuitry 32, configured to select any two piece of structured data in the structured data set to form a plurality of structured data pairs; a calculating circuitry 33, configured to perform a similarity calculation on each of the plurality of structured data pairs to obtain a similarity value for each structured data pair; and a classifying circuitry 34, configured to classify structured data in the structured data pair having the similarity value is greater than a predetermined similarity threshold into a same data subject.

In some embodiments, each piece of data in the set of data includes feature information, wherein the feature information includes at least one of the following items: time information, spatial location information, and identification information of the data subject.

In some embodiments, the structured processing circuitry 31 may include: a first extracting sub-circuitry 311; for the set of data, configured to extract feature information carried in each piece of the data to obtain respective feature extraction result for each piece of data; a first processing sub-circuitry 312, for each feature extraction result of each piece of data, configured to perform the data structuring on each feature extraction result in accordance with at least one of time information, spatial location information, and identification information of the data subject to obtain all data features of each piece of data; a second processing sub-circuitry 313, configured to process all data features of each piece of data in accordance with a predetermined structured data format to obtain the plurality of structured data for each piece of data; and a forming sub-circuitry 314, configured to form the structured data set based on the plurality of structured data for each piece of data.

In some embodiments, the calculating circuitry 33 may include: a second extracting sub-circuitry 331, for any structured data in each structured data pair, based on a predetermined subject knowledge library, configured to attempt to extract a subject feature from all data features of the structured data, wherein the predetermined subject knowledge library includes a plurality of data subjects, and at least one subject feature for representing each data subject, wherein the at least one subject feature is configured to uniquely identify a data subject to which the structured data belongs; and a first calculating circuitry 332, if both of two pieces of structured data in the structured data pair include the subject feature, configured to perform the similarity calculation on the two subject features.

In some embodiments, the subject feature is described by a plurality of subject identifiers, and the first calculating circuitry 332 is configured to determine a cross subject identifier of the two subject features to obtain at least one cross subject identifier pair; perform the similarity calculation on the at least one cross subject identifier pair when there is at least one cross subject identifier pair to obtain similarity calculation results for the at least one cross subject identifier pair respectively; and weigh the respective similarity calculation result for the at least one cross subject identifier.

In some embodiments, the first calculating circuitry 332 is configured to use a cosine similarity formula to perform the similarity calculation on the at least one cross subject identification pair.

In some embodiments, the calculating circuitry 33 may further include: a third extracting sub-circuitry 333, for any structured data in each structured data pair, based on a predetermined subject knowledge library, configured to attempt to extract a subject feature from all data features of the structured data, wherein the predetermined subject knowledge library includes a plurality of data subjects, and at least one subject feature for representing each data subject, wherein the at least one subject feature is configured to uniquely identify a data subject to which the structured data belongs; a fourth extracting sub-circuitry 334; based on a predefined subject dimension library, configured to extract other data features in the structured data except the subject feature, wherein the predefined subject dimension library includes various data features for describing the data subject; a second calculating sub-circuitry 335, for any structured data in each structured data pair, configured to perform the similarity calculation on the subject feature and the other data features respectively to obtain similarity calculation results for the subject feature and the other data features; and a weighting circuitry 336, configured to weigh the similarity calculation results of the subject feature and the other data features.

In some embodiments, the second calculating sub-circuitry 335 is further configured to use a cosine similarity formula to perform the similarity calculation on the subject feature and the other data features respectively.

In some embodiments, the device 3 for data fusion may further include: a fusing circuitry 35, configured to fuse data features in the structured data belonging to the same data subject.

In some embodiments, the fusing circuitry 35 may include: a fusing sub-circuitry 351, configured to use an inter-relationship diagraph to fuse data features in the structured data belonging to the same data subject

For more details about the working principle and mode of the device for data fusion 3, reference may be made to the related description in embodiments shown in FIG. 1 and FIG. 2, which are not described herein again.

Further, embodiments of the disclosure provide a non-transitory storage medium, storing computer instructions, wherein once the computer instructions are executed, the method in embodiments shown in FIG. 1 and FIG. 2 is performed. In some embodiments, the storage medium may include a computer readable storage medium such as a non-volatile memory or a non-transitory memory. The storage medium may include a ROM, a RAM, a magnetic disk, an optical disk, or the like.

Further, embodiments of the disclosure provide a server, which includes a memory and a processor, wherein the memory stores computer instructions executable on the processor, and the processor executes the method in embodiments shown in FIG. 1 and FIG. 2 when executing the computer instructions.

Although the present disclosure has been disclosed above with reference to preferred embodiments thereof, it should be understood that the disclosure is presented by way of example only, and not limitation. Those skilled in the art may modify and vary the embodiments without departing from the spirit and scope of the present disclosure.

What is claimed is:

1. A method for data fusion comprising:
performing a data structuring on an obtained set of data to obtain a structured data set including a plurality of structured data;
selecting any two pieces of structured data in the structured data set to form a plurality of structured data pairs;
performing a similarity calculation on each of the plurality of structured data pairs to obtain a similarity value for each structured data pair; and
classifying structured data in the structured data pair having the similarity value greater than a predetermined similarity threshold into a same data subject.

2. The method for data fusion according to claim 1, wherein each piece of data in the set of data comprises feature information, wherein the feature information comprises at least one of the following items: time information, spatial location information, and identification information of the data subject.

3. The method for data fusion according to claim 2, wherein the performing a data structuring on an obtained set of data to obtain a structured data set including a plurality of structured data comprises:
for the set of data, extracting feature information carried in each piece of the data to obtain respective feature extraction result for each piece of data;
for each feature extraction result of each piece of data, performing the data structuring on each feature extraction result in accordance with at least one of time information, spatial location information, and identification information of the data subject to obtain all data features of each piece of data;
processing all data features of each piece of data in accordance with a predetermined structured data format to obtain the plurality of structured data for each piece of data; and
forming the structured data set based on the plurality of structured data for each piece of data.

4. The method for data fusion according to claim 3, wherein the performing a similarity calculation on each of the plurality of structured data pairs comprises:
for any structured data in each structured data pair, based on a predetermined subject knowledge library, attempting to extract a subject feature from all data features of the structured data, wherein the predetermined subject knowledge library comprises a plurality of data subjects, and at least one subject feature for representing each data subject, wherein the at least one subject feature is configured to uniquely identify a data subject to which the structured data belongs; and
if both of two pieces of structured data in the structured data pair comprise the subject feature, performing the similarity calculation on the two subject features.

5. The method for data fusion according to claim 4, wherein the subject feature is described by a plurality of subject identifiers, and the performing the similarity calculation on the two subject features comprises:
determining a cross subject identifier of the two subject features to obtain at least one cross subject identifier pair;
performing the similarity calculation on the at least one cross subject identifier pair when there is at least one cross subject identifier pair to obtain similarity calculation results for the at least one cross subject identifier pair respectively; and
weighting the respective similarity calculation result for the at least one cross subject identifier.

6. The method for data fusion according to claim 5, wherein the performing the similarity calculation on the at least one cross subject identifier pair comprises:
using a cosine similarity formula to perform the similarity calculation on the at least one cross subject identification pair.

7. The method for data fusion according to claim 3, wherein the performing a similarity calculation on each of the plurality of structured data pairs comprises:
for any structured data in each structured data pair, based on a predetermined subject knowledge library, attempting to extract a subject feature from all data features of the structured data, wherein the predetermined subject knowledge library comprises a plurality of data subjects, and at least one subject feature for representing each data subject, wherein the at least one subject feature is configured to uniquely identify a data subject to which the structured data belongs;
based on a predefined subject dimension library, extracting other data features in the structured data except the subject feature, Wherein the predefined subject dimension library comprises various data features for describing the data subject;
for any structured data in each structured data pair, performing the similarity calculation on the subject feature and the other data features respectively to obtain similarity calculation results for the subject feature and the other data features; and
weighting the similarity calculation results of the subject feature and the other data features.

8. The method for data fusion according to claim 7, wherein the performing the similarity calculation on the subject feature and the other data features respectively comprises:
using a cosine similarity formula to perform the similarity calculation on the subject feature and the other data features respectively.

9. The method for data fusion according to claim 1 further comprising:
fusing data features in the structured data belonging to the same data subject.

10. The method for data fusion according to claim 1, wherein the fusing data features in the structured data belonging to the same data subject comprises:
using an inter-relationship diagraph to fuse data features in the structured data belonging to the same data subject.

11. A device for data fusion comprising:
a structured processing circuitry, configured to perform a data structuring on an obtained set of data to obtain a structured data set including a plurality of structured data;
a selecting circuitry, configured to select any two piece of structured data in the structured data set to form a plurality of structured data pairs;
a calculating circuitry, configured to perform a similarity calculation on each of the plurality of structured data pairs to obtain a similarity value for each structured data pair; and
a classifying circuitry, configured to classify structured data in the structured data pair having the similarity value is greater than a predetermined similarity threshold into a same data subject.

12. A non-transitory storage medium, storing computer instructions, wherein once the computer instructions are executed, the method according to claim 1 is performed.
